(19) United States
(12) Patent Application Publication
(10) Pub. No.: US 2016/0097647 A1
(43) Pub. Date: Apr. 7, 2016

(54) ROUTE PLANNING SYSTEM, ROUTE PLANNING METHOD AND TRAFFIC INFORMATION UPDATE METHOD

(71) Applicant: INSTITUTE FOR INFORMATION INDUSTRY, Taipei (TW)

(72) Inventors: Jyun-Naih LIN, Taipei City (TW); Frank Chee-Da TSAI, Taipei City (TW)

(21) Appl. No.: 14/529,163

(22) Filed: Oct. 31, 2014

(30) Foreign Application Priority Data
Oct. 2, 2014 (TW) 103134425

(51) Int. Cl. G01C 21/34

(52) U.S. Cl. CPC G01C 21/34

(57) ABSTRACT

A route planning system includes a network server. The network server includes a plurality of road section data, in which each road section data includes a distance and a plurality of average speed rate data corresponding to a plurality of time intervals. The route planning system calculates at least one possible route according to a departure time, a departure point, and a destination point. The possible route includes a plurality of possible road sections from the departure point to the destination point. The route planning system dynamically searches the average speed rate data of the estimated passing time intervals according to the possible road sections and the distances respectively to calculate the travel time of each possible road section and adds them to receive a total travel time of the possible route.

### RELATED APPLICATIONS

This application claims priority to Taiwan Application Serial Number 103134425, filed Oct. 2, 2014, which is herein incorporated by reference.

### BACKGROUND

1. Field of Invention

The present disclosure relates to a route planning system. More particularly, the present disclosure relates to a route planning system with community-supported collaboration.

2. Description of Related Art

Navigation systems and online maps currently available on the market lack traffic speed data of actual road sections, and are usually configured to use constant vehicle speed to estimate driving time. Thus, such navigation systems and online maps cannot adjust an estimated vehicle speed according to changes in different time intervals, resulting in a significant difference between an estimated travel time and an actual travel time.

In addition, street images of the presently available navigation systems and online maps are usually obtained periodically by personnel in the industry at major intersections or obtained using a street view car. As a consequence, such street images are updated too infrequently, and moreover, they cannot show changes in the street views for different time intervals, such as for day and night.

### SUMMARY

One aspect of the present disclosure is a route planning system. According to an embodiment of the present disclosure, the route planning system includes a network server. The network server includes a plurality of first road section data, wherein each first road section data includes a distance and a plurality of average speed rate data corresponding to a plurality of time intervals respectively. The route planning system calculates at least one possible route according to a departure time, a departure point, and a destination point. The at least one possible route includes a plurality of possible road sections passed from the departure point to the destination point. The route planning system dynamically searches the average speed rate data of the corresponding time intervals according to the possible road sections and the distances respectively to receive at least one total travel time of the at least one possible route.

Another aspect of the present disclosure is a route planning method. The route planning method includes searching a plurality of possible routes according to a departure time, a departure point, and a destination point, in which each of the possible routes includes a plurality of possible road sections from the departure point to the destination point; and calculating a plurality of total travel times corresponding to the possible routes respectively, in which calculating the total travel time corresponding to one of the possible routes includes dynamically searching a plurality of average speed rate data of a plurality of corresponding time intervals according to the possible road sections of the possible route.

Yet another aspect of the present disclosure is a driving information update method. The driving information update method includes receiving a time data, a location data and a speed data uploaded by an electrical device; searching a corresponding road section data according to the location data and the time data; and adjusting a corresponding average speed data in the road section data according to the speed data.

In summary, in the present disclosure, a time-dividing and section-dividing method is applied to estimate the total travel time. A route image matching the travel time interval is provided for users to browse, and using speed and image data sent back by users in the community, the real-time reliability and accuracy of the information in the network server are ensured. Thus, improvements are realized with respect to the problems encountered using present navigation systems and route planning technology, such as significant errors in estimated travel time and the slow update frequency of street images.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a diagram illustrating a route planning system according to an embodiment of the present disclosure;

FIG. 2 is a flow chart illustrating a route planning system according to an embodiment of the present disclosure;

FIG. 3 is a diagram illustrating route planning according to an embodiment of the present disclosure;

FIG. 4 is a diagram illustrating a database according to an embodiment of the present disclosure;

FIG. 5 is a flow chart of a method of calculating a total travel time according to an embodiment of the present disclosure;

FIG. 6A is a diagram illustrating calculating the total travel time according to an embodiment of the present disclosure;

FIG. 6B is a diagram illustrating calculating the total travel time according to an embodiment of the present disclosure; and

FIG. 7 is a flow chart of a driving information update method according to an embodiment of the present disclosure.

### DETAILED DESCRIPTION

Reference will now be made in detail to embodiments of the present disclosure, examples of which are described herein and illustrated in the accompanying drawings. While the disclosure will be described in conjunction with embodiments, it will be understood that they are not intended to limit the invention to these embodiments. On the contrary, the invention is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

In the following description and in the claims, the terms “include” and “comprise” are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

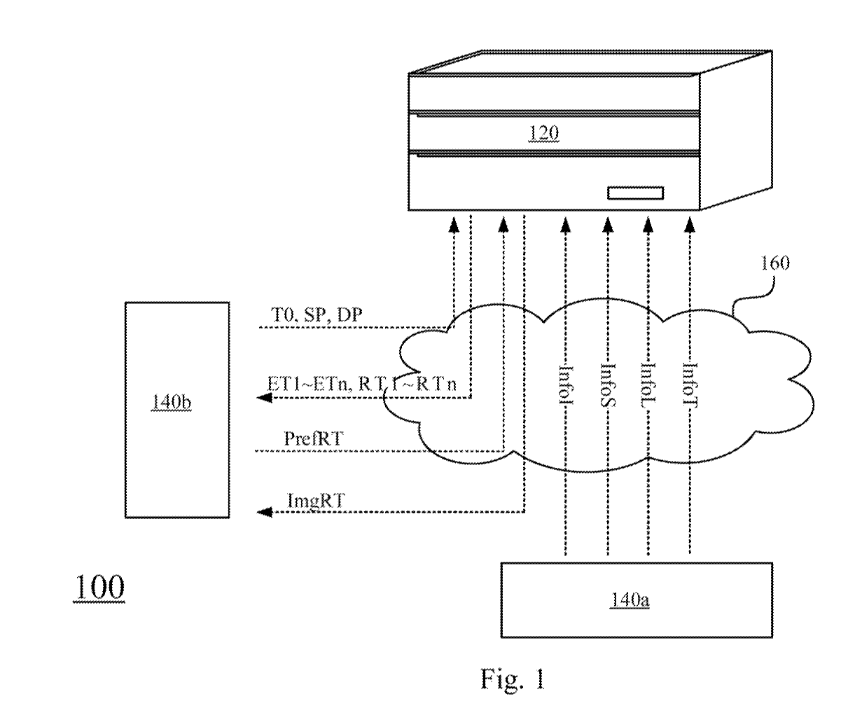

One aspect of the present disclosure is a route planning system. Reference is made to FIG. 1. FIG. 1 is a diagram illustrating a route planning system 100 according to an embodiment of the present disclosure. The route planning system 100 includes a network server 120. A user may connect to the network server 120 through the internet 160 by an electronic device 140b (e.g., a computer, a smartphone, or a navigation device)

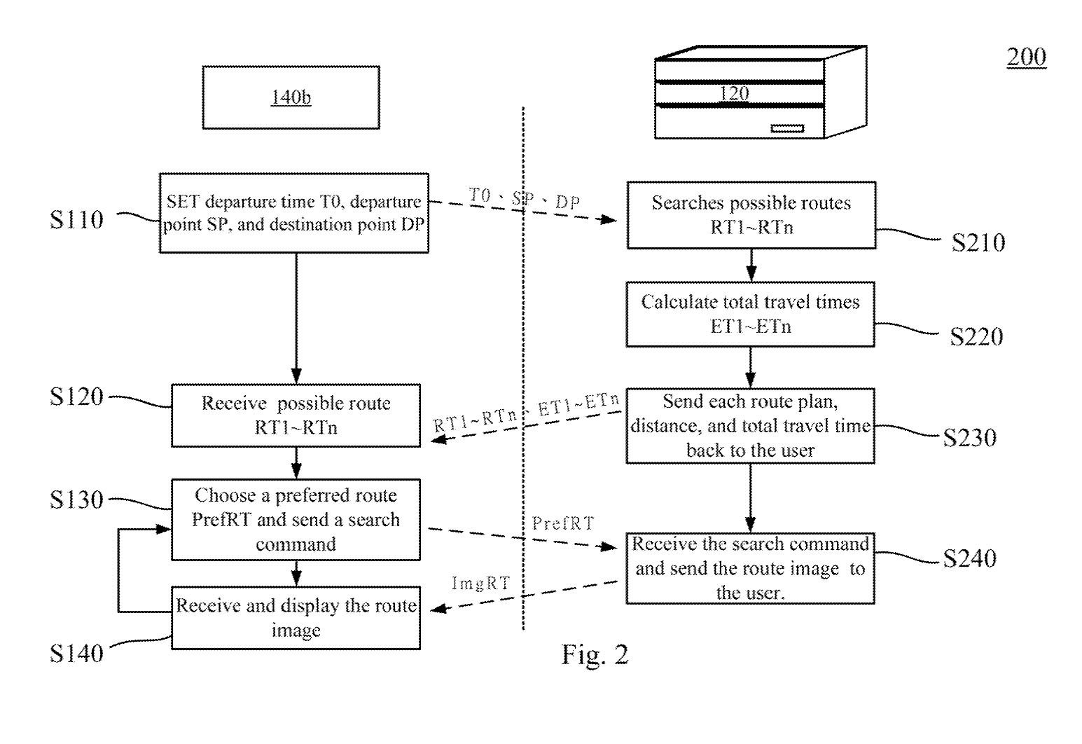

Referring to FIG. 1 and FIG. 2, during the process of route planning, the user transmits a departure time T0, a departure point SP, and a destination point DP to the network server 120 through the internet 160 by the electronic device 140b, as shown in step S110. In response to receiving a searching command from the user, the route planning system 100 searches at least one possible route RT1 according to the departure time T0, the departure point SP, and the destination point DP. In some embodiments, the network server 120 may further search multiple possible routes RT1˜RTn, as shown in step S210. For example, the network server 120 may search possible routes RT1˜RTn through a navigation engine (not shown) or a geographical information system (not shown).

In step S210, the route planning system 100 searches multiple possible routes RT1˜RTn according to the departure time T0, the departure point SP, and the destination point DP. Each of the possible routes RT1˜RTn includes a plurality of possible road sections passed through from the departure point SP to the destination point DP.

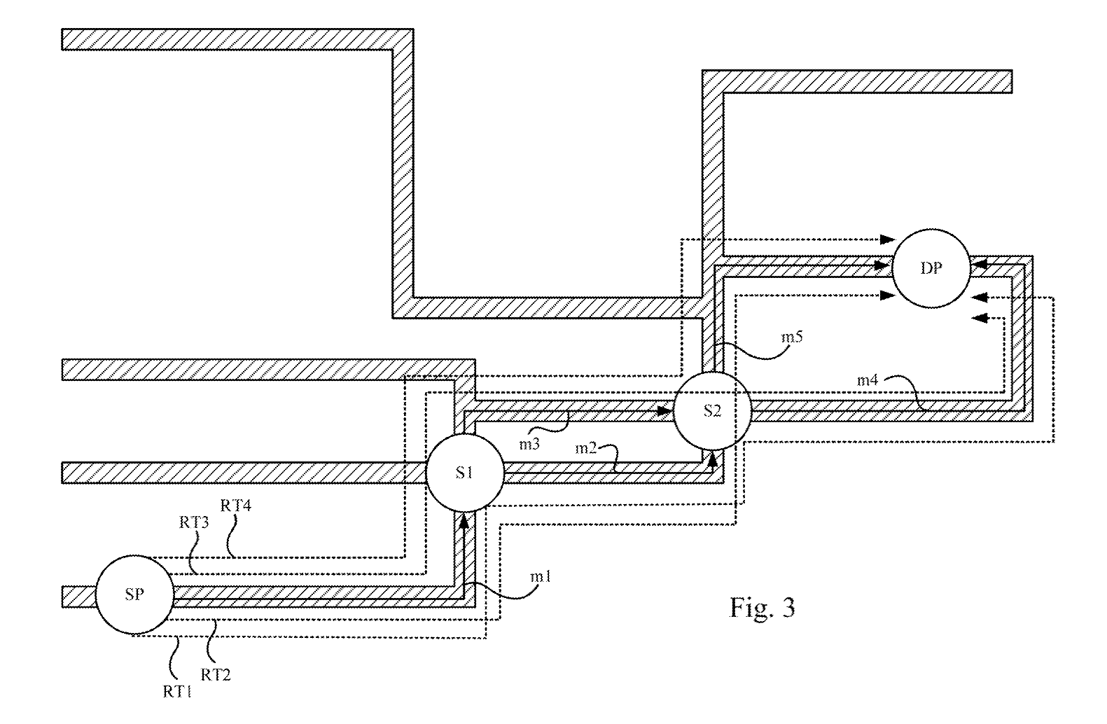

Reference is made to FIG. 3. For example, as shown in FIG. 3, any of the possible routes RT1˜RT4 includes possible road sections m1˜m5 from the departure point SP, passing by a midpoint S1 and a midpoint S2 to the destination point DP. For example, the possible route RT1 includes the possible road section m1 starting from the departure point SP, the possible road section m2 starting from the midpoint S1, and the possible road section m4 starting from the midpoint S2. Similarly, the possible route RT2 includes the possible road sections m1, m2 and m5; the possible route RT3 includes the possible road sections m1, m3 and m4; and the possible route RT4 includes the possible road sections m1, m3 and m5. It is noted that the examples illustrated in FIG. 3 are only used for better understanding of the present disclosure and are not meant to limit the present disclosure. The number of the possible routes RT1˜RTn and the number of the midpoints may be configured according to actual needs.

In step S220, the network server 120 calculates corresponding total travel times ET1˜ETn of the possible routes RT1˜RTn respectively. In an embodiment, when calculating the corresponding total travel times ET1˜ETn of the possible routes RT1˜RTn respectively in step S220, a time-dividing dynamical estimation process is performed according to an estimated passing time of each possible road section, in order to calculate a more precise travel time of each section at different times. Details of the processes of step S220 will be explained in paragraphs to follow.

Next, in step S230, the network server 120 sends each route plan, distance, and total travel time ET1˜ETn of the possible routes RT1˜RTn back to the user. In step S120, the user receives the information sent from the network server 120.

In some embodiments, the user may further choose one of the possible routes RT1˜RTn as a preferred route PrefRT and send a search command to the network server 120 as shown in step S130. In step S240, the network server 120 receives the search command and combines a plurality of image data corresponding to the time intervals corresponding to the possible road sections of the preferred route PrefRT to be a route image ImgRT, and sends the route image ImgRT to the user.

After the route image ImgRT is received and displayed, the user may also choose another possible route RT1˜RTn as the new preferred route PrefRT to repeatedly search the route image ImgRT corresponding to the different possible route.

The method of calculating the total travel time corresponding to one of the possible routes, for example, the total travel time ET1 corresponding to the possible route RT1, includes searching the network server 120 dynamically according to the corresponding possible road section m1, m2, and m4 of the possible route RT1.

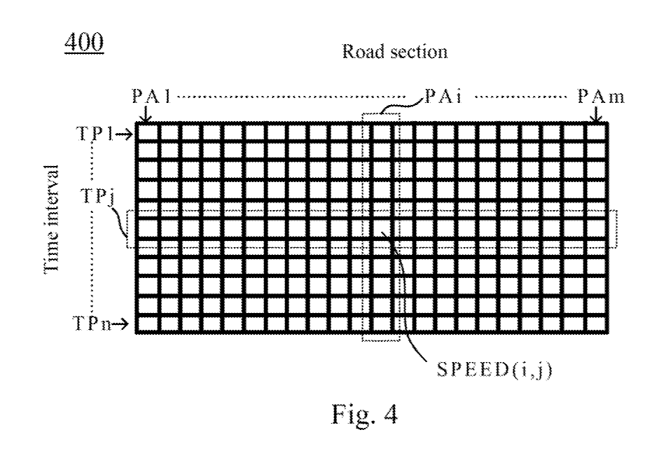

As shown in FIG. 4, a plurality of road section data PA1˜PAm are stored in a database of the network server 120. For example, the road section data PA1˜PAm may be the road sections divided by a certain distance, and may also be configured to be the location path ID defined by a location table in the stored information. In other words, each possible road section m1, m2 and m4 is corresponded to a different road section data PA1˜PAm.

Each of the road section data PA1˜PAm includes a plurality of average speed data SPEED (i,j) corresponding to a plurality of time intervals TP1˜TPn. That is to say, depending on the particular road section location and particular time interval, the network server 120 includes average speed data SPEED (i,j) corresponding to the average speed of the road section data PAi at the time interval TPj.

The unit of the time intervals TP1˜TPn may be configured according to actual needs. For example, the network server 120 is configured to choose 30 minutes, 1 hour, 2 hours, or any other time interval as a basic unit to divide the time intervals TP1˜TPn. Different time intervals TP1˜TPn may also be configured depending on the day of the week (Monday to Sunday), or depending on whether there is a national holiday. Average speed data SPEED (i,1)˜SPEED (i,n) in one specific road section data PAi may correspond to a speed at a different time interval.

Specifically, for example, in an embodiment, average speed data SPEED (i,1)˜SPEED (i,n) may correspond to the average speed of the road section from 6:00 AM to 9:00 AM on Monday, from 9:00 AM to 12:00 PM on Monday, from 6:00 PM to 9:00 PM on Sunday, from 9:00 PM to 12:00 AM on Sunday, etc. Thus, for the same road section, information about the average speed during on-peak and off-peak time intervals are stored in the network server 120 to be referenced for subsequent route planning processes.

In some embodiments, the time intervals TP1˜TPn may have different lengths. For example, during the on-peak rush hours, each time interval may be configured with 15 minutes as the basic unit. During the off-peak periods such as midnight or early morning hours, each time interval may be configured with 2 hours as the basic unit. Thus, the average speed data SPEED (i,j) is more precise during on-peak time intervals, whereas during off-peak time intervals, storing an excessive amount of unnecessary information in the network server 120 is avoided.

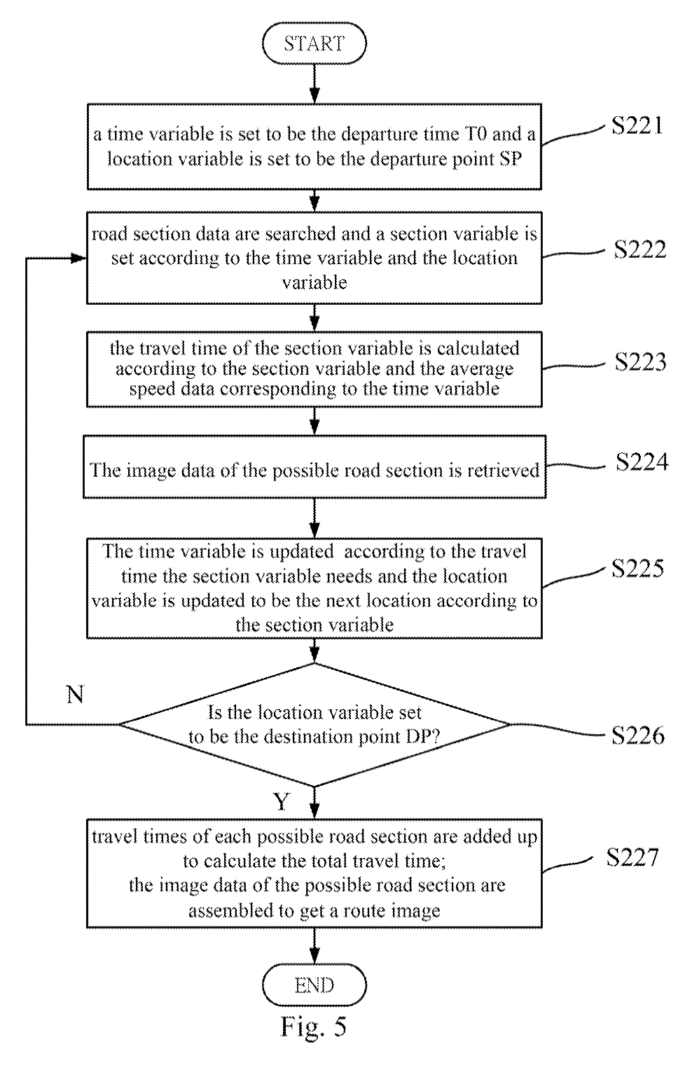

A method of dynamically searching the network server 120 according to the possible road sections m1, m2, and m4 of the possible route RT1 will now be described with reference to FIG. 5. In some embodiments, in the aforementioned step S220, the steps of calculating the total travel time (e.g., the travel time ET1) corresponding to one of the possible routes (e.g., the possible route RT1) further includes steps S221-S227.

First, in step S221, a time variable is set to be the departure time T0 and a location variable is set to be the departure point SP. In step S222, the road section data PA1˜PAm in network server 120 are searched and a section variable is set to be the corresponding road section data according to the time variable and the location variable. In step S223, the travel time of the section variable is calculated according to the section variable and the average speed data SPEED(i,j) corresponding to the time variable

In step S225, the network server 120 updates the time variable according to the travel time the section variable needs and updates the location variable to be the next location according to the section variable. Subsequently, in step S226, the network server 120 determines whether the location variable is set to be the destination point DP, and if not, re-calculates the travel time according to the updated location variable and the updated time variable until the location variable is set to be the destination point DP.

Finally, in step S227, travel times of each possible road section are added up to calculate the total travel time ET1.

In some embodiments, the aforementioned procedure may further include step S224. In step S224, the network server 120 retrieved the image data of the possible road section according to the corresponding road section data PA1˜PAm and the corresponding time variable. In step S227, the image data of the possible road section are assembled to get a route image ImgRT.

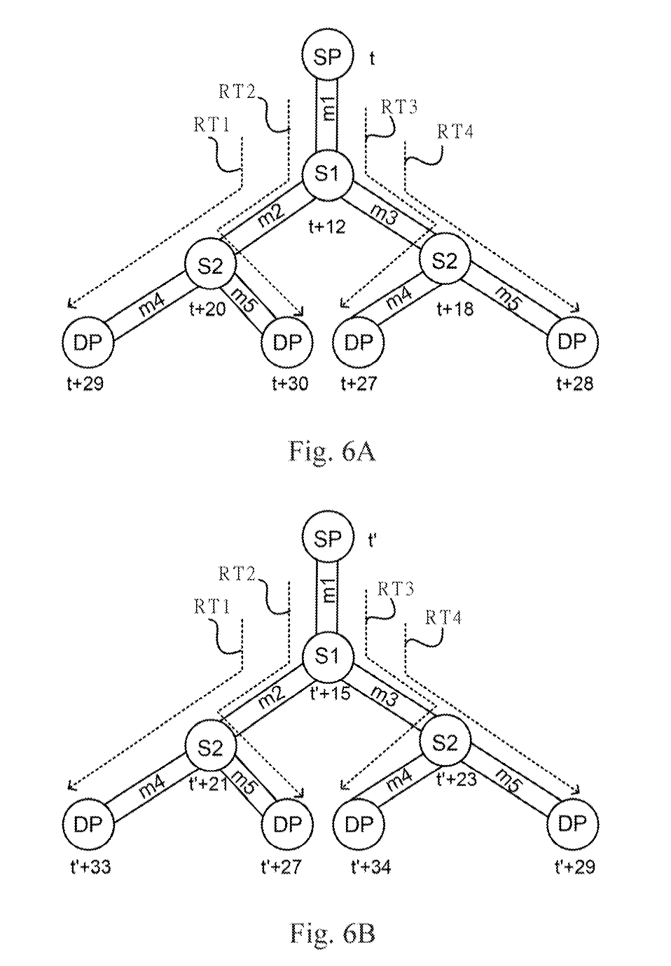

A specific example is described with reference to FIG. 3 and FIG. 6A. As shown in FIG. 3, the possible routes RT1˜RT4 from the departure point SP to the destination point DP include different combinations of the possible road sections m1˜m5 respectively. In FIG. 6A, when the network server 120 calculates the total travel time ET1 corresponding to the possible route RT1, if the user sets the departure time T0 to be a time t, the network server 120 sets the time variable to be the time t, and searches the possible road section m1 connecting the location variable (i.e., the departure point SP) to the next location (i.e., the midpoint S1) according to the time t, and calculates the travel time of the possible road section m1 according to the corresponding average speed data and the distance of the possible road section m1. For example, in the present embodiment, the travel time of the possible road section m1 is 12 minutes.

Next, the time variable is updated to be (t+12), and the location variable is updated to be the midpoint S1. The network server 120 searches the possible road section m2 connecting the location variable (i.e., the midpoint S1) to the next location (i.e., the midpoint S2) according to time (t+12), and calculates the travel time of the possible road section m2 according to the corresponding average speed data and the distance of the possible road section m2. In the present embodiment, the travel time of the possible road section m2 is 8 minutes.

Finally, the time variable is updated to be (t+20), and the location variable is updated to be the midpoint S2. The network server 120 searches the possible road section m4 connecting the location variable (i.e., the midpoint S2) to the next location (i.e., the destination point DP) according to time (t+20), and calculates the travel time of the possible road section m4 according to the corresponding average speed data and the distance of the possible road section m4. In the present embodiment, the travel time of the possible road section m4 is 9 minutes. Thus, the total travel time ET1 of the possible route RT1 is determined to be 29 minutes.

According to the embodiment mentioned above, for each possible road section m1, m2, and m4 in the possible route RT1, the average speed rate data SPEED(i,j) of the corresponding time intervals TP1˜TPn in the database is searched according to each estimated passing time (i.e., the time variable), as shown in FIG. 4.

Similarly, the above operation may also be applied to the possible routes RT2, RT3, and RT4, and the corresponding total travel times ET2, ET3, and ET4 are 30 minutes, 27 minutes, and 28 minutes respectively. Finally, the routes and distances of the possible routes RT1˜RT4 and the total travel times ET1˜ET4 are provided to the user for reference.

In addition, the user may also adjust and configure different departure times for reference when planning. As shown in FIG. 6B, if the user changes the departure time T0 to be a time t′, as a result of the different departure time, the average speed data corresponds to different time intervals TP1˜TPn. In the present disclosure, if the departure time T0 is set to be the time t′, in the possible route RT1, the travel time corresponding to the possible road section m1 is 15 minutes, the travel time corresponding to the possible road section m2 is 6 minutes when the time variable is time (t′+15), and the travel time corresponding to the possible road section m4 is 12 minutes when the time variable is time (t′+21), so the total travel time ET1 changes to 33 minutes. Similarly, after the above operation is applied to the possible routes RT2, RT3, and RT4, the corresponding total travel times ET2, ET3, and ET4 are 27 minutes, 34 minutes, and 29 minutes respectively.

That is to say, referring to FIG. 6A and FIG. 6B, if departing at the time t, the time needed for the possible route RT3 is the shortest at 27 minutes. On the other hand, the time needed for the possible route RT2 is the shortest at 27 minutes if departing at the time t′.

It is noted that, when the same departure time T0 is set, the time needed by the same possible road section is not constant; rather, the travel time is determined by different time intervals searched in the database according to the estimated passing time of each possible road section. For example, in the example shown in FIG. 6B, for the same possible road section m4, the travel time of the possible road section m4 in the possible route RT1 is 12 minutes; on the other hand, the travel time of the possible road section m4 in the possible route RT3 is 11 minutes. This discrepancy is due to the estimated passing time of the possible road section m4 being different for the possible route RT1 and the possible route RT3 (the time variables are t′+21 and t′+23, respectively). Thus, the database replies with each travel time according to the different estimated passing times dynamically.

When the route planning system 100 calculates the total travel times ET1˜ET4 of the multiple possible routes RT1˜RT4 respectively, the route planning system 100 may provide the route and the distance of the possible routes RT1˜RT4 and the total travel times ET1˜ET4 to the user for reference, so that the user may choose the most convenient or the most time-saving route.

In addition, the route planning system 100 may also calculate the total travel time ET1 of the same possible route RT1 at a different departure time T0 and provide this information to the user for reference when planning a departure time.

As shown in FIG. 1, in an embodiment, the route planning system 100 may further include an electronic device 140a. The electronic device 140a is located in a vehicle and configured to be connected to the network server 120 through the internet 160. The network server 120 is configured to update the road section data PA1˜PAm according to a time data InfoT, a location data InfoL, and a speed data InfoS uploaded by the electrical device 140a, in which the time data infoT and the location data InfoL indicate respectively the time and the road of the vehicle during operation. For example, the location data InfoL may include location coordinates and a direction data respectively indicating the location and moving direction of the electronic device 140a, and thus indicating the road of the vehicle during operation. The speed data infoS indicates the speed of the vehicle during operation.

For example, the electronic device 140a may be a vehicle operation recorder, a navigation device, or a smartphone. The electronic device 140a internally includes a location module (e.g., a global positioning system), a time module and a processing module to get the time data InfoT, the location data InfoL, and the speed data InfoS respectively. The time data InfoT, the location data InfoL, and the speed data InfoS may be uploaded to the network server 120 through the internet 160 by a communication module.

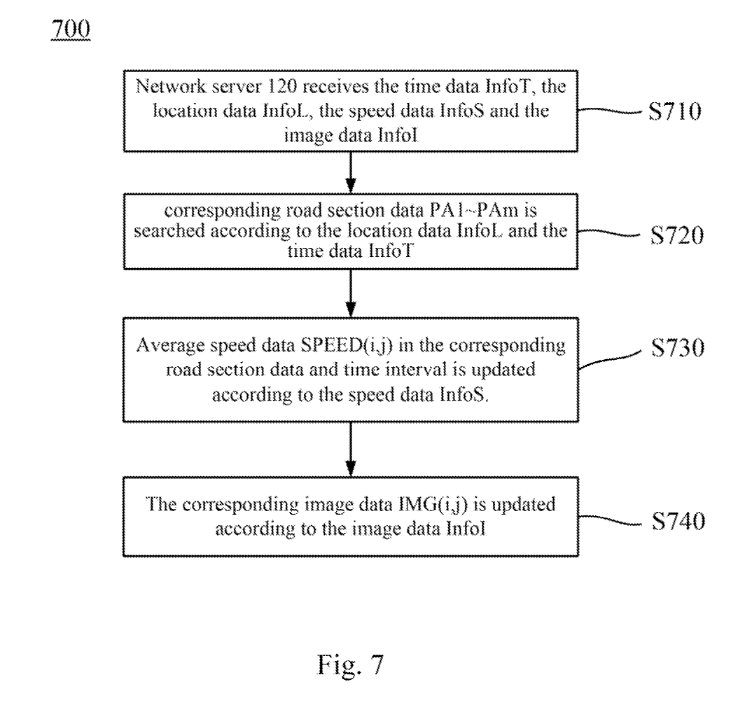

As shown in FIG. 7, a driving information update method 700 includes steps S710, S720, S730, and S740. First, in step S710, the network server 120 receives the time data InfoT, the location data InfoL, and the speed data InfoS uploaded by the electrical device 140a. Subsequently, in step S720, corresponding road section data PA1˜PAm is searched according to the location data InfoL and the time data InfoT. In step S730, average speed data SPEED(i,j) is updated in the corresponding road section data and time interval according to the speed data InfoS.

That is to say, the electronic device 140a may be configured to reply to the network server 120 with the speed of the vehicle passing a specific road section at a specific time, and the network server 120 updates the average speed data of the corresponding road section data of the corresponding time interval according to the data provided by the electronic device 140a. Thus, the average speed data SPEED(i,j) in the database of the network server 120 will continuously be updated and become more and more accurate with the data provided by the electronic device 140a from the user.

There are various different methods in which the network server 120 updates the average speed data SPEED(i,j). For example, the network server 120 may add up the average speed data SPEED(i,j) multiplied by a first weight (e.g., 0.5) and the speed data InfoS provided by the electronic device 140a multiplied by a second weight (e.g., 0.5) to calculate the adjusted average speed data SPEED(i,j). The sum of the first weight and the second weight is 1, and the proportional distribution may be configured according to actual needs. For example, the first weight may be set as 0.8 and the second weight may be set as 0.2, or the first weight may be set as 0.6 and the second weight may be set as 0.4.

In some embodiments, the road section data PA1˜PAm in the network server 120 may further include image data IMG(i,j) corresponding to different time intervals TP1˜TPn respectively. The electronic device may further include an image module (e.g., a camera) in order to receive image data InfoI. In step S710, the image data InfoI uploaded from the electronic device 140a is further received. In step S740, the corresponding image data IMG(i,j) in the database is adjusted and updated according to the image data InfoI.

That is to say, the electronic device 140a may be configured to provide the image of the vehicle passing a specific road section at a specific time to the network server 120, and the network server 120 updates the image data of the corresponding road section data of the corresponding time interval according to the data provided by the electronic device 140a. Thus, the image data IMG(i,j) in the database of the network server 120 will continuously be updated with the data provided by the electronic device 140a from the user.

Hence, the route planning system 100 may be configured to display the actual street view image to the user, and due to the image data IMG(i,j) configured to distinguish data according to the different time intervals and to update in real time continuously, changes in the street view are reflected faithfully and the problem of outdated information is rarely encountered.

The above illustrations include exemplary operations, but the operations are not necessarily performed in the order shown. The order of the operations disclosed in the present disclosure may be changed, or the operations may even be executed simultaneously or partially simultaneously as appropriate, in accordance with the spirit and scope of various embodiments of the present disclosure.

In summary, in the present disclosure, by applying the embodiments mentioned above, a time-dividing and section-dividing method is used to estimate the total travel time. A route image matching the travel time interval is provided for users to browse, and using speed and image data sent back by users in the community, the real-time reliability and accuracy of the information in the network server are ensured. Thus, improvements are realized with respect to the flaws and issues encountered when using present navigation technology.

Although the disclosure has been described in considerable detail with reference to certain embodiments thereof, it will be understood that the embodiments are not intended to limit the disclosure. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A route planning system comprising:
a network server comprising a plurality of road section data, wherein each road section data comprises a distance and a plurality of average speed rate data corresponding to a plurality of time intervals;
wherein the route planning system calculates at least one possible route according to a departure time, a departure point, and a destination point;
wherein the at least one possible route comprises a plurality of possible road sections from the departure point to the destination point, and the route planning system dynamically searches the average speed rate data of the corresponding time intervals of a plurality of estimated passing time according to the possible road sections and the distances respectively to receive at least one total travel time of the at least one possible route;
wherein dynamically searching the average speed rate data of corresponding time intervals according to the possible road sections and the distances comprises searching the time intervals of each estimated passing time of the possible road sections starting from the departure time sequentially to receive the average speed rate data of the possible road sections at each estimated passing time.

2. (canceled)

3. The route planning system of claim 1, further comprising:
an electrical device located in a vehicle;
wherein any one of the road section data is configured to update the road section data according to a time data, a section data, and a speed data uploaded by the electrical device,
wherein the time data and the section data respectively indicate the time and the road section of the vehicle during operation, and the speed data indicates the speed of the vehicle during operation.

4. The route planning system of claim 3, wherein each of the road section data further comprises an image data, and any one of the road section data is configured to update the corresponding image data according to an image data uploaded by the electrical device.

5. The route planning system of claim 1, wherein the time intervals have different lengths respectively.

6. A route planning method, comprising:
searching a plurality of possible routes according to a departure time, a departure point, and a destination point, wherein each of the possible routes comprises a plurality of possible road sections from the departure point to the destination point; and
calculating a plurality of total travel times corresponding to the possible routes respectively;
wherein calculating the total travel time corresponding to one of the possible routes comprises dynamically searching a plurality of average speed rate data of a plurality of corresponding time intervals according to the possible road sections of the possible route;
wherein dynamically searching the average speed rate data of corresponding time intervals according to the possible road sections and the distances comprises searching the time intervals of a plurality of estimated passing time of the possible road sections starting from the departure time sequentially to receive the average speed rate data of the possible road sections at each estimated passing time.

7. The route planning method of claim 6, wherein the step of calculating the total travel time corresponding to one of the possible routes comprises:
setting a time variable to be the departure time;
setting a location variable to be the departure point;
searching a plurality of road section data in a network server and setting a section variable to be the corresponding road section data according to the time variable and the location variable;
calculating a travel time of the section variable according to the section variable and an average speed data corresponding to the time variable;
updating the time variable according to the travel time of the section variable;
updating the location variable according to the section variable and re-calculating the travel time according to the updated location variable and the updated time variable until the location variable is set to be the destination point; and
adding up each travel time to calculate the total travel time.

8. The route planning method of claim 6, further comprising:
combining a plurality of image data corresponding to the time intervals corresponding to the possible road section of a configured preferred route to be a route image; and
displaying the route image.

9. A driving information update method comprising:
receiving a time data, a location data and a speed data uploaded by an electrical device;
searching a corresponding road section data according to the location data and the time data, wherein the road section data includes a plurality of average speed data corresponding to a plurality of time intervals; and
adjusting the average speed data corresponding to the time interval of the time data in the road section data according to the speed data.

10. The driving information update method of claim 9, wherein the step of adjusting the average speed data comprises:
adding up the average speed data multiplied by a first weight and the speed data multiplied by a second weight to calculate the adjusted average speed data.
